(19) United States
(12) Patent Application Publication
(10) Pub. No.: US 2004/0022492 A1
(43) Pub. Date: Feb. 5, 2004

(54) Optical device

(76) Inventors: John Edward Gunther, Morgan Hill, CA (US); Edward Keat Leem Chan, Oakland, CA (US); Milan Momcilo Popovich, Leicester (GB); John James Storey, Nottingham (GB)

Correspondence Address: John E. Gunther, 18400 Serra Avenida, Morgan Hill, CA, 95037, US

(21) Appl. No.: 10/400,590

(22) Filed: Mar. 27, 2003

(30) Foreign Application Priority Data
Jul. 31, 2002 (WO) PCT/GB02/03530

(51) Int. Cl. G02B 6/26

(52) U.S. Cl. 385/40; 385/11

(57) ABSTRACT

A layer of optically active material overlaps the mode filed of a single mode optical waveguide and has regions to which electric fields can be applied by way of respective electrodes so as to vary the refractive index of the layer in those regions. The regions are spaced apart longitudinally of the waveguide, and the fields are so arranged that they extend at different angles to an interface between the waveguide and the layer and act sequentially upon different polarisation components of radiation propagating along the waveguide. In one arrangement, the fields are orthogonal to one another. In an alternative arrangement, the third field can be applied to a further longitudinally-spaced region of the layer and the three fields are arranged at 120 degrees to one another.

### FIELD OF THE INVENTION

This invention relates to an optical device.

### BACKGROUND TO THE INVENTION

U.S. Pat. No. 5,937,115 of Domash describes a family of electro-optical devices which comprise an optical waveguide fabricated on, or just under, the surface of a waveguide substrate, a layer of polymer-dispersed liquid crystal (PDLC) material in which a Bragg diffraction grating has been formed, and a cover plate. The cover plate and/or the waveguide substrate have electrodes thereon for applying an electric field across the PDLC layer, in order to rotate the orientation of the liquid crystal molecules and thereby change the diffraction efficiency of the Bragg grating and/or the average refractive index of the PDLC layer. Such devices can be used, for example, as wavelength-selective filters or attenuators in fibre-optic communications systems.

Devices intended for use in optical communications systems must have low polarisation-dependent loss (PDL) and low polarisation mode dispersion (PMD). PDL is defined as the variation in device insertion loss or attenuation as a function of the polarisation state of the input optical signal. PMD is defined as the variation in phase shift or transit time through the device as a function of the polarisation state of the input optical signal. To satisfy these requirements, the devices must be essentially independent of the polarisation state of the input signal. This can be very difficult to achieve in any component utilising a material that has inherent birefringence, such as PDLC or nematic liquid crystal material.

One solution is to separate the two orthogonal polarisation components using e.g. a polarising beamsplitter, pass the two resultant beams independently through the device, and then recombine the two beams at the other end. This approach is commonly termed “polarisation diversity”, but might be more correctly called “parallel polarisation diversity” because the two polarisation components pass through the device along separate, usually parallel paths. However, the need to provide polarising beamsplitters and beam combiners adds to the complexity and therefore cost of the device.

It is an object of the present invention to obviate or mitigate this problem.

### SUMMARY OF THE INVENTION

According to a first aspect of the present invention, there is provided an optical device comprising:

a single-mode optical waveguide having a portion through which optical signals can propagate in a longitudinal direction;

a region of optically active material which at least overlaps a mode field of the waveguide and which forms an interface with the waveguide, the material of said region being such that its refractive index can be varied by applying an electric field thereto; and

an electrode arrangement by means of which there can be applied a first electric field to a first part of said region and a second electric field to a second part of said region, said first and second parts of said region being spaced from one another in the longitudinal direction of said waveguide, said first and second electric fields being generally orthogonal to one another and also being transverse to the longitudinal direction of said waveguide.

Advantageously, the material of said region has an extraordinary axis which is aligned parallel to the longitudinal direction of the waveguide.

The region of optically active material can be composed of a polymer-dispersed liquid crystal material in which interference fringes are recorded, with the planes of said fringes being oriented normal to the longitudinal direction of the waveguide. Alternatively, the region can be composed of nematic liquid crystal material.

In one embodiment, the electrode arrangement is such that the first and second electric fields are applied in directions that are respectively generally parallel with and generally normal to said interface.

The electrode arrangement can comprise first electrodes which produce said first electric field when an electrical potential is applied thereto, the first electrodes being spaced apart from one another transversely to the longitudinal direction of the waveguide.

The electrode arrangement can comprise second electrodes which produce said second electric field when an electrical potential is applied thereto, the second electrodes being spaced apart in another direction that is transverse to both said one direction and to the longitudinal direction of the waveguide. Alternatively, one of the second electrodes can extend longitudinally of the waveguide, and the other second electrodes can be spaced therefrom in said one direction.

In an alternative embodiment, the electrode arrangement is such that the first and second electric fields are applied in respective directions that are both at an angle to the interface between the waveguide and said region. In a particular example of this, the first and second electric fields are applied generally at angles of +45° and −45° respectively to said interface.

The electrode arrangement can comprise a first electrode set including a first electrode generally aligned with a core of the waveguide and a second electrode positioned obliquely to one side of said core, and a second electrode set including a first electrode generally aligned with said core and a second electrode positioned obliquely to the opposite side of said core. The first electrode of the first electrode set and the first electrode of the second electrode set can comprise a common electrode extending in the longitudinal direction of the waveguide.

Desirably, the electrode arrangement is operative such that at least one of the first and second electric fields varies in magnitude in the longitudinal direction of the waveguide. This can be achieved by positioning electrodes of the electrode arrangement at an angle to the longitudinal direction of the waveguide.

Conveniently, said region of optically active material is formed as a layer on a surface of said waveguide.

According to a second aspect of the present invention, there is provided an optical device comprising:

a single-mode optical waveguide having a portion through which optical signals can propagate in a longitudinal direction;

a region of optically active material which at least overlaps a mode field of the waveguide and which forms an interface with the waveguide, the material of said region being such that its refractive index can be varied by applying an electric field thereto; and

an electrode arrangement by means of which there can be applied a plurality of electric fields to respective parts of said region that are spaced from one another in the longitudinal direction of said waveguide, said plurality of electric fields being transverse to the longitudinal direction of the waveguide and having their field vectors directed at respective different angles with respect to said interface.

Desirably, the field vectors of said electric fields are directed at respective angles that are generally equi-angularly spaced from one another. In a preferred embodiment, the electrode arrangement is such that three electric fields are applied, and such that their field vectors are angularly spaced at intervals of generally 120°. Conveniently, the three electric fields are applied in directions that are essentially parallel to said interface and at angles of +60° and −60° to said interface, respectively.

According to a third aspect of the present invention, there is provided an optical device comprising:

a single-mode optical waveguide having a portion through which optical signals can propagate in a longitudinal direction;

a region of optically active material which at least overlaps a mode field of the waveguide and which forms an interface with the waveguide, the material of said region being such that its refractive index can be varied by applying an electric field thereto; and

an electrode arrangement by means of which there can be applied a first electric field to a first part of said region, a second electric field to a second part of said region and a third electric field to a third part of said region, said first, second and third parts of said region being spaced from one another in the longitudinal direction of the waveguide, the first, second and third electric fields being directed transversely of said waveguide and at respective different angles to said interface that are angularly spaced from one another at intervals of generally 120°.

### BRIEF DESCRIPTION OF THE DRAWINGS

The invention will now be further described, by way of example only, with reference to the accompanying drawings, in which:

FIG. 1 is a schematic exploded perspective view of an optical device according to the present invention;

FIG. 2 is a more detailed perspective view, again in schematic form, of the device shown in FIG. 1;

FIGS. 3A to 3C are schematic sectional views showing different electrode arrangements for the device;

FIGS. 4A and 4B are schematic sectional views showing other electrode arrangements;

FIGS. 5A and 5B are plan views of two different electrode arrangements;

FIGS. 6A and 6B are schematic sectional views showing a further electrode arrangement;

FIG. 6C is a schematic plan view of the electrode arrangement shown in FIGS. 6A and 6B;

FIGS. 7A and 7B are schematic sectional views of a still further electrode arrangement;

FIG. 7C is a schematic plan view of the electrode arrangement shown in FIGS. 7A and 7B;

FIGS. 8A and 8B are schematic sectional views of yet another electrode arrangement;

FIG. 8C is a schematic plan view of the electrode arrangement shown in FIGS. 8A and 8B;

FIG. 9 is a schematic plan view of a modified electrode arrangement;

FIGS. 10A and 10B are sectional views of an alternative embodiment of the optical device; and

FIGS. 11A to 11C are similar views of a further alternative embodiment.

### DETAILED DESCRIPTION

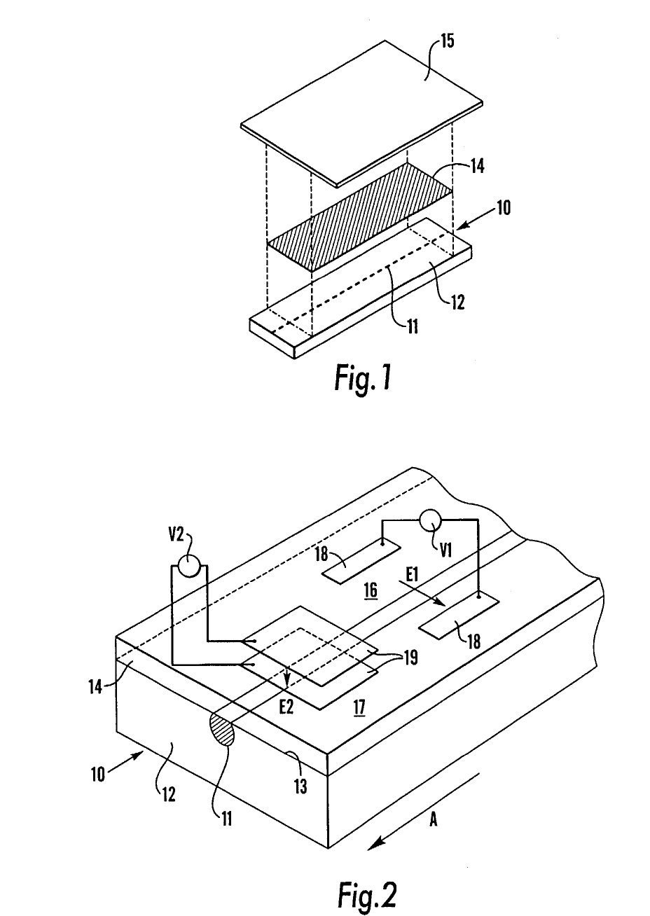

Referring first to FIGS. 1 and 2, the optical device shown therein comprises a single-mode planar optical waveguide circuit in the form of an optical waveguide 10 having a core 11 along which an optical signal can propagate and a surrounding cladding region 12. The core 11 is exposed at an upper surface 13 of the cladding 12, and is optically in contact with an overlying region or layer 14 of optically active material. The layer 14 is in turn protected by a glass cover 15 (not shown in FIG. 2). Although the device is shown as comprising a single core 11, it is to be understood that the invention is equally applicable to devices containing two or more parallel cores. An optical signal can be inputted to and outputted from the waveguide 10 by suitable devices (not shown) coupled to the ends of the core 11. For example, single-mode optical fibres can be aligned with and bonded to the core ends, or lenses can be employed instead.

The material comprising the layer 14 is a uni-axial electro-optical material, such as PDLC material, nematic liquid crystal material, or any other material that has a unique extraordinary axis that can be aligned parallel to a longitudinal axis A of the core 11 during fabrication of the device. In the case where PDLC material is used, this alignment can be achieved by recording a diffraction grating within the material and by arranging for the planes of the interference fringes to be oriented parallel to the axis A. In the case where nematic liquid crystal material is used, the alignment can be accomplished by rubbing the surfaces of the waveguide 10 and the cover 15, or by other techniques that are well-known in the art.

The device also comprises an electrode arrangement for applying electric fields to respective parts or regions 16, 17 of the layer 14 which are spaced apart in the longitudinal direction of the waveguide 10, i.e. in the direction of the axis A. More particularly, the electrode arrangement is composed of a first set of electrodes 18 which apply a first electric field E1 to the region 16 when a potential is applied thereto from a voltage source V1, and a second set of electrodes 19 which apply a second electric field E2 to the region 17 when a potential is applied thereto from a voltage source V2. The electrodes 18 are arranged such that electric field E1 is oriented normal to the waveguide axis A and substantially parallel to the waveguide surface 13, whereas the electrodes 19 are arranged such that the electric field E2 is oriented normal to the waveguide axis A but substantially orthogonal to the waveguide surface 13. It will thus be appreciated that the electric fields E1 and E2 are generally orthogonal to one another.

Considering first the region 16, application of the electric field E1 by way of the electrodes 18 will cause the extraordinary axis of the material in the layer 14 to rotate in the direction of the electric field vector. In the case where the layer 14 is composed of PDLC material, this is comes about due to the molecules of liquid crystal re-orienting under the influence of the electric field. Generally speaking, the greater the magnitude of the applied electric field, the greater will be the degree to which the extraordinary axis rotates. This will cause a change in the apparent characteristics of the material in the layer 14 (such as the average refractive index or, if interference fringes are present, the modulation in the refractive index caused by the fringes), in such a manner that the layer will interact with a portion of one polarisation component of light propagating along the waveguide 10. In this particular instance, it is the TE component of the light that is affected, namely the component whose electric field vector is parallel to the waveguide surface 13. Again, the greater the magnitude of the applied electric field E1, the greater the portion of the TE component that is affected.

Considering now the region 17, application of the electric field E2 by way of the electrodes 19 will similarly cause the extraordinary axis of the material in the layer 14 to rotate in the direction of the electric field vector. However, whereas in region 16 this rotation is towards a direction parallel to the waveguide surface 13, in the region 17 the rotation is towards a direction orthogonal to the surface 13. As a result, the region 17 will interact with the component of the light propagating within the waveguide 10 of orthogonal polarisation to that described previously, namely the TM component whose electric field vector is orthogonal to the waveguide surface 13. As before, the degree of this interaction will be dependent upon the magnitude of the applied electric field E2.

In general terms, any optical signal propagating along the waveguide core 11 will be composed of orthogonally-polarised TE and TM components. By applying suitable voltages across the electrodes 18 and the electrodes 19, the electric fields E1 and E2 can be adjusted so as to increase or decrease the degree of optical coupling between the core 11 and the layer 14 in the region 16 on the one hand, and between the core 11 and the layer 14 in the region 17 on the other. This in turn will alter the degree to which the TE and TM polarisation components are affected. Because this happens in areas that are encountered sequentially by the optical signal, one may refer to this technique as “sequential polarisation diversity” to distinguish it over the methods used previously.

The interaction between the optical signal and the regions 16 and 17 of the layer 14 can take a variety of forms. For example, by raising the average refractive index of the region 16 or 17 (as seen by the respective TE or TM polarisation component) to a value approximately equal to the effective index of the guided mode (which is about equal to the refractive index of the waveguide core 11), some of the light in the signal can be out-coupled from the core 11. By employing this effect, the overall device can be operated as a variable attenuator. Since the degree of attenuation of the TE and TM polarisation components can be separately controlled by means of the electrodes 18 and 19 respectively, the overall device can be operated to achieve zero PDL by arranging for the two components to be attenuated to the same degree. Alternatively, the device can be used to offset PDL in some other part of the system by arranging for the attenuation of the two components to be offset to a predetermined degree.

Alternatively, if the average refractive index of the region 16 or 17 (as seen by the respective TE or TM polarisation component) is raised but without exceeding the value of the refractive index of the waveguide core 11, then this will simply alter the propagation time of that component through the device. Because the propagation times for the TE and TM components can be altered independently of one another by suitable operation of the electrodes 18 and 19, the propagation times of the two components can be altered with respect to one another, and this can be used to compensate for PMD.

As a further alternative, where the layer 14 incorporates interference fringes, altering the refractive index modulation caused by the fringes will result in wavelength-selective coupling of light from the waveguide core 11 to forward- or backward propagating modes in the layer 14 or in the glass cover 15. This effect can be utilised in the design of a variety of wavelength-selective filters.

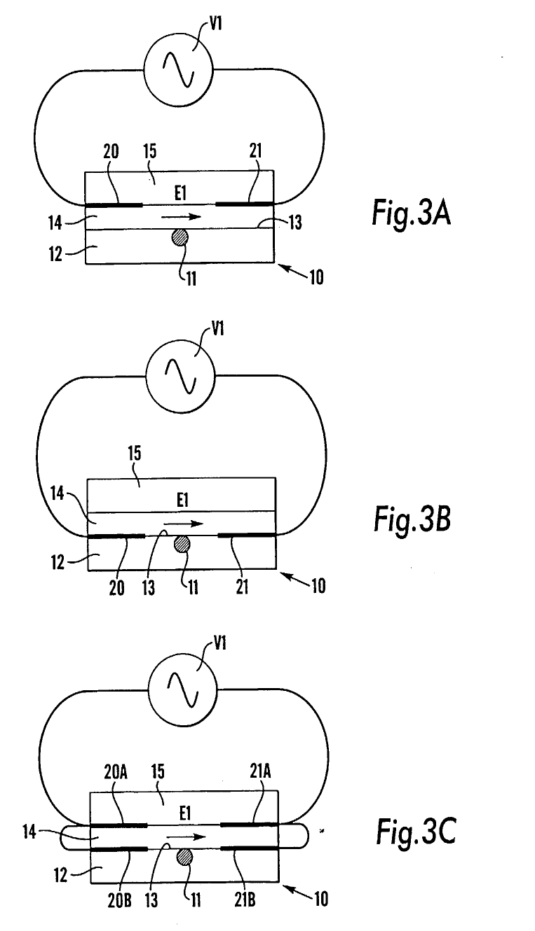

In FIG. 3A, there is shown a first arrangement for the electrode set 18. In this arrangement, thin film electrodes 20 and 21 are deposited on the interface between the layer 14 and the cover 15. The electrodes 20 and 21 are spaced apart to either side of the waveguide core 11 such that, when an electrical potential is applied by way of the voltage source V1, the electric field E1 is generated with its field director transverse to the core 11 but essentially parallel to the waveguide surface 13 (the nominal field direction being indicated by an arrow).

FIG. 3B shows a similar arrangement, but in which the thin film electrodes 20 and 21 are deposited instead on the interface between the waveguide 10 and the layer 14.

FIG. 3C shows an arrangement which effectively combines the arrangements of FIGS. 3A and 3B. More particularly, the electrode set 18 now comprises a first pair of thin film electrodes 20A and 21A deposited on the interface between the layer 14 and the cover 15, and a second pair of thin film electrodes 20B and 21B deposited on the interface between the waveguide 10 and the layer 14. The electrodes 20A and 20B are connected in common to one terminal of the voltage supply V1, while the electrodes 21A and 21B are similarly connected in common to its other terminal. Although this arrangement does involve the extra cost of depositing an additional electrode pair, it does provide a more uniform electric field.

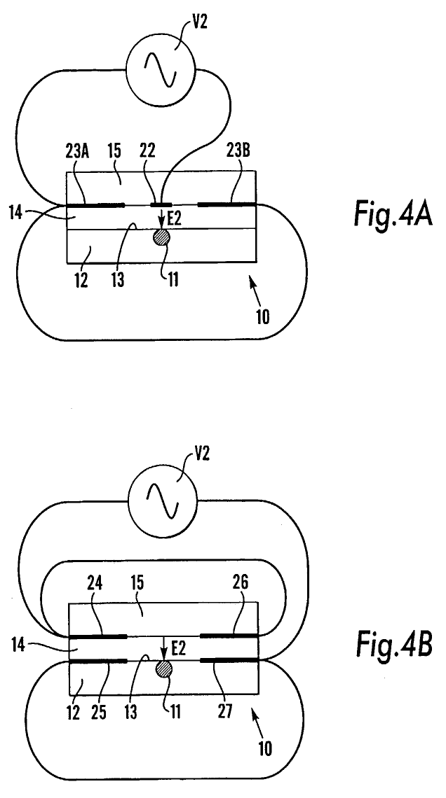

FIG. 4A shows one arrangement for the electrode set 19. In this arrangement, thin film electrodes 22 and 23 are deposited on the interface between the layer 14 and the cover 15. The electrode 22 is aligned with the waveguide core 11, whilst the electrode 23 comprises two portions 23A and 23B which are positioned respectively to either side of the core 11 in spaced relation to the electrode 22. When an electrical potential is applied by way of the voltage source V2, the electric field E2 is generated with its field director transverse to the core 11 and generally orthogonal to the waveguide surface 13 (the nominal field direction being indicated by an arrow).

FIG. 4B shows an alternative arrangement where the electrode set 19 comprises a first pair of thin film electrodes 24 and 25 deposited respectively on the interface between the layer 14 and the cover 15, and on the interface between the waveguide 10 and the layer 14, and disposed to one side of the waveguide core 11. A second pair of thin film electrodes 26 and 27 is similarly deposited, but to the other side of the core and in spaced relation to the electrodes 24 and 25. The electrodes 24 and 26 are electrically connected together and to one terminal of the voltage supply V2, whilst the electrodes 25 and 27 are electrically connected together and to the other terminal of the supply. When an electrical potential is applied to these electrodes, the electric field E2 is again generated with its field director transverse to the core 11 and generally orthogonal to the waveguide surface 13 (the nominal field direction being indicated by an arrow). However, in this arrangement the field is more uniform at the expense of having to provide an extra electrode pair.

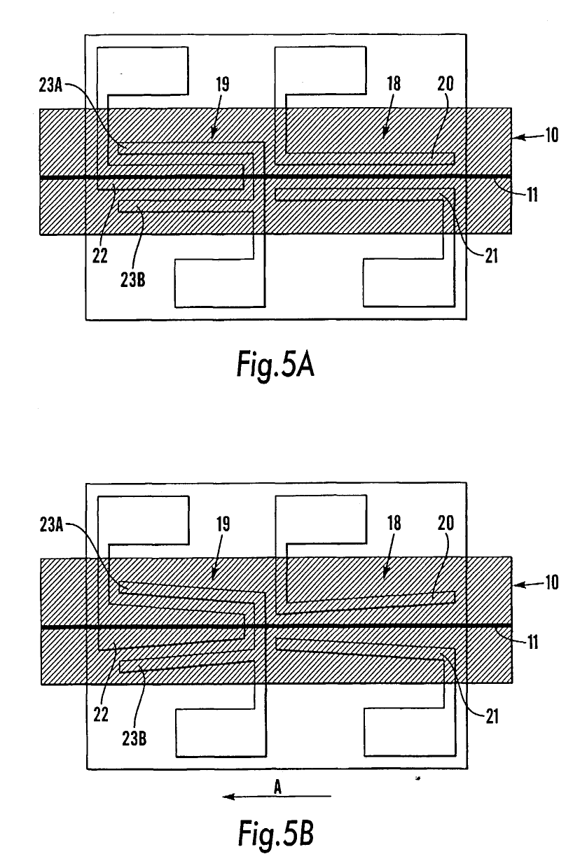

FIG. 5A shows a typical configuration of the electrode arrangement in plan view, and combines the construction for the electrodes 18 shown for example in FIG. 3A with the construction for the electrodes 19 shown in FIG. 4A. In this configuration, the various electrodes all have operative portions which extend parallel to the waveguide core 11. FIG. 5B shows a modified configuration in which these portions extend at an angle to the core axis A. This creates in each case an electric field that varies in strength at different positions along the core 11, and this can be used to control the relationship between the applied voltage and the degree of interaction between the layer 14 and the light propagating along the core 11.

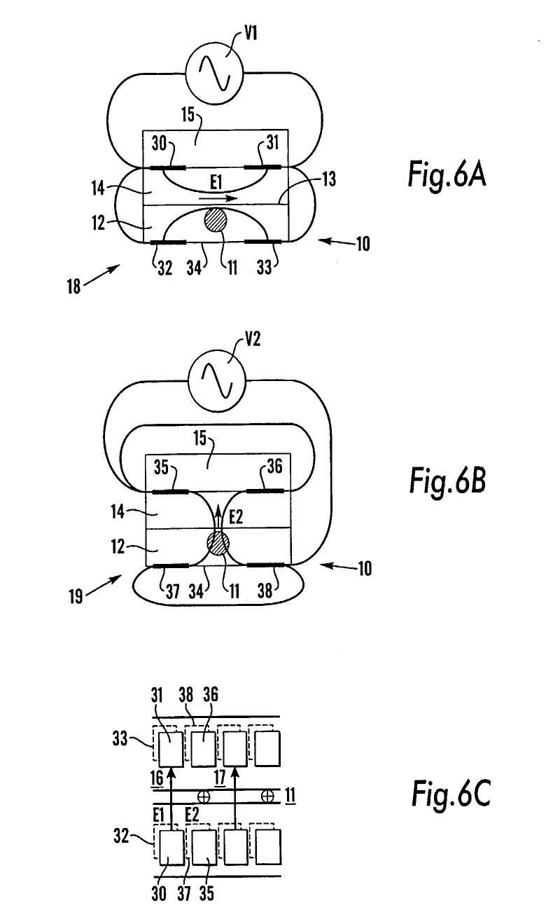

FIGS. 6A to 6C illustrate an alternative electrode arrangement for generating electric fields that are, respectively, generally normal to and generally parallel with the interface 13. FIG. 6A shows the electrode set 18, which comprises a pair of thin film electrodes 30 and 31 deposited on the interface between the layer 14 and the cover 15 and positioned to opposite sides of the waveguide core 11, and a further pair of thin film electrodes 32 and 33 deposited on a bottom surface 34 of the waveguide 10 and again positioned to opposite sides of the core 11. The electrodes 30 and 32 are connected in common to one terminal of the voltage source V1, whilst the electrodes 31 and 33 are connected in common to the other terminal thereof. When a potential is applied to the electrodes by way of the voltage source V1, an electric field E1 is produced that extends essentially parallel with the interface 13 between the layer 14 and the waveguide 10, at least in the area where the core 11 is disposed.. If desired, one of the pairs of electrodes 30 and 31, 32 and 33 can be omitted.

The electrode set 19 is shown in FIG. 6B, and comprises two thin film electrodes 35 and 36 deposited on the interface between the layer 14 and the cover 15 and positioned respectively to opposite side of the waveguide core 11, and two further thin film electrodes 37 and 38 deposited on the bottom surface 34 of the waveguide 10 and similarly positioned respectively to either side of the core 11. Whilst this arrangement is similar to hat described above with reference to FIG. 6A, the electrodes 35 and 37 are now connected in common to one terminal of the voltage source V2, whilst the electrodes 36 and 38 are connected in common to the other terminal thereof. When a potential is applied to the electrodes by way of the voltage source V2, an electric field E2 is produced that extends essentially normal to the interface 13 between the layer 14 and the waveguide 10, at least in the area where the waveguide core 11 is disposed. If desired, one of the electrode pairs 35 and 37, 36 and 38 can be omitted.

As depicted in FIG. 6C, these two types of electrode constructions can alternate in the longitudinal direction of the core 11.

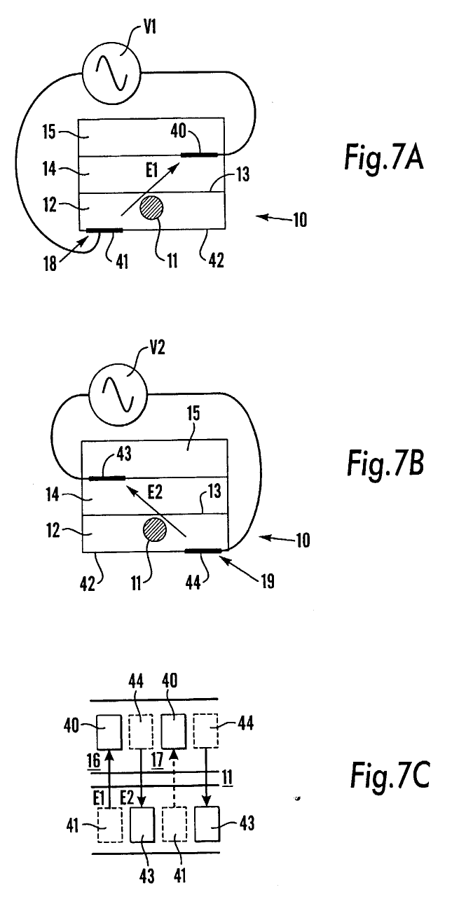

FIGS. 7A to 7C show another possible construction for the electrode arrangement. More particularly, as can be seen to advantage in FIG. 7A, the electrode set 18 comprises a thin film electrode 40 which is deposited on the interface between the layer 14 and the cover 15, and a thin film electrode 41 which is deposited on a bottom surface 42 of the waveguide 10. As viewed in plan (see FIG. 7C), the two electrodes 40 and 41 are disposed respectively to opposite sides of the waveguide core 11. When an electrical potential is applied by way of the voltage source V1, an electric field E1 is generated which extends at approximately +45° to the interface 13 between the layer 14 and the waveguide 10.

As can be seen to advantage in FIG. 7B, the electrode set 19 also comprises a thin film electrode 43 deposited on the interface between the layer 14 and the cover 15, and a thin film electrode 44 deposited on the bottom surface 42 of the waveguide 10. As with the electrode set 18, the electrodes 43 and 44 when viewed in plan (see FIG. 7C) are disposed respectively to opposite sides of the core 11, but this disposition is in the opposite sense to that of the electrodes 40 and 41. Thus, when a potential is applied to the electrodes 43 and 44 by means of the voltage source V2, an electric field E2 is produced which extends at approximately −45° to the interface 13.

In this construction, it will be appreciated that the fields E1 and E2 are still generally orthogonal to one another, but they are both inclined at an angle to the interface 13. As depicted in FIG. 7C, the two electrode arrangements shown in FIGS. 6A and 6B can be alternated in the longitudinal direction of the waveguide core 11.

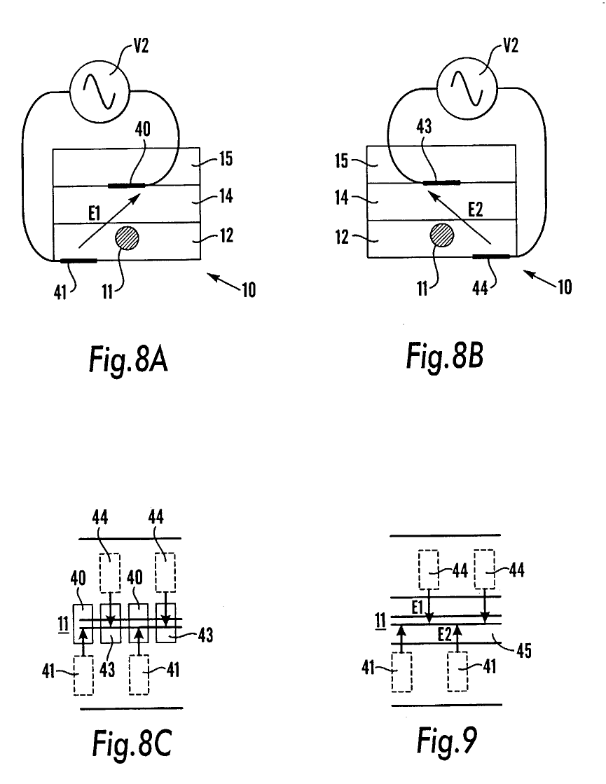

FIGS. 8A to 8C show another electrode arrangement which is generally similar to that of FIGS. 7A to 7C, and therefore similar parts are accorded the same reference numerals. In FIG. 8A, however, the uppermost electrode 40 is positioned in general alignment with the waveguide core 11. Similarly, in FIG. 8B the uppermost electrode 43 is positioned in general alignment with the core 11 also. FIG. 8C shows these two types of electrode constructions alternating in the longitudinal direction of the core 11.

In FIG. 9, there is shown an alternative arrangement wherein the uppermost electrodes 40 and 43 are replaced by a single common electrode 45 that extends in the longitudinal direction of the waveguide core 11.

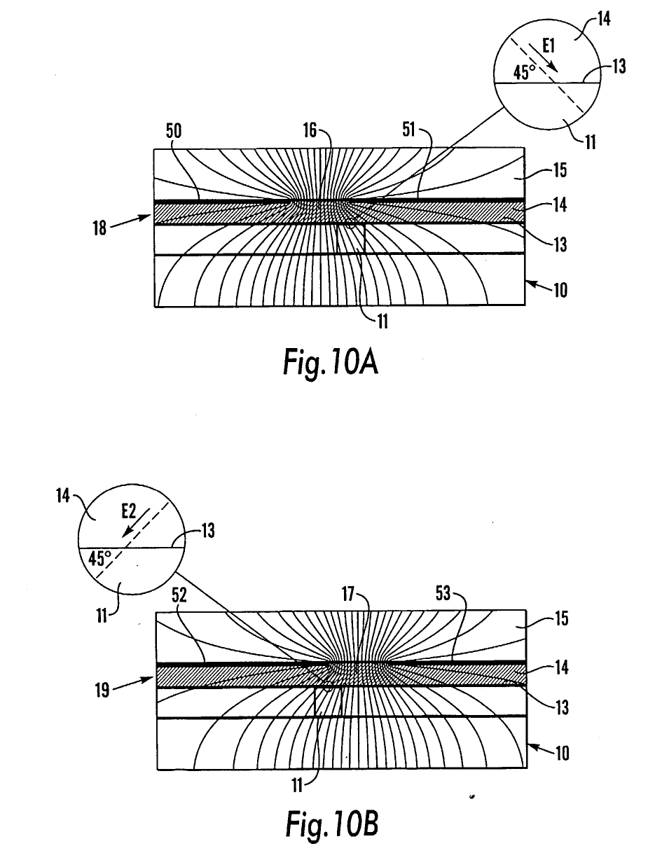

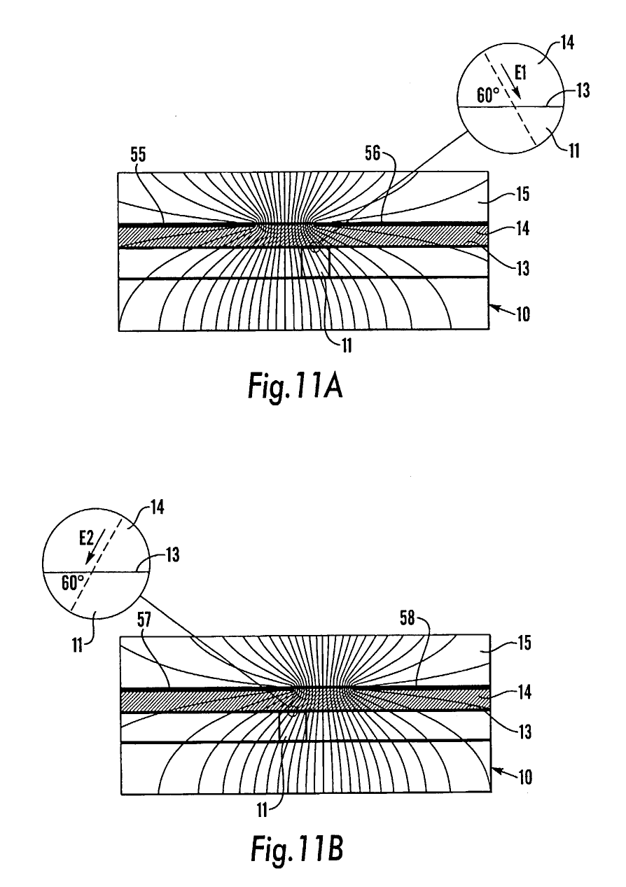

In FIGS. 10A and 10B, there is shown an alternative embodiment in which the electrode set 18 comprises a pair of thin film electrodes 50 and 51 deposited on the interface between the layer 14 and the cover 15. The electrodes 50 and 51 are spaced apart transversely of the waveguide core 11, but the gap between them is laterally offset from the core. The electrode set 19 similarly comprises a pair of thin film electrodes 52 and 53 deposited on the interface between the layer 14 and the cover 15, and in which the gap between them is laterally offset from the core 11 but in the opposite direction.

As can be seen to advantage in FIG. 10A, the electrodes 50 and 51 are so positioned relative to the waveguide core 11 that the latter is located in a region where the electric field E1 extends at essentially +45° to the waveguide surface 13. Similarly, as can be seen to advantage from FIG. 10B, the electrodes 52 and 53 are so positioned relative to the waveguide core 11 that the latter is located in a region where the electric field E2 extends at essentially −45° to the waveguide surface 13. The respective insets to these Figures show the electric field director at the interface between the core 11 and the layer 14 in each case. Thus, as in the arrangements of FIGS. 7A to 7C, FIGS. 8A to 8C and FIG. 9, the electric fields E1 and E2 are still generally orthogonal to one another, but they extend at an angle to the surface 13 rather than being essentially parallel and orthogonal thereto, respectively.

The arrangements of the above-mentioned Figures have the advantage that the configurations of the electrodes in the two regions 16 and 17 are mirror images of one another, so the electrodes can be made to work with the same applied voltage. Although the two electric fields no longer act on the TE and TM components of the optical signal (i.e. the components parallel with and orthogonal to the waveguide surface 13), they are still operative on two different orthogonally-polarised components of the signal.

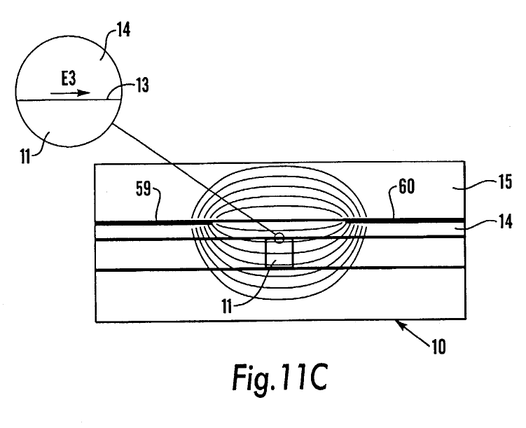

FIGS. 11A to 11C show an alternative embodiment, in which the electrode arrangement comprises a first electrode pair 55 and 56, a second electrode pair 57 and 58, and a third electrode pair 59 and 60 which are disposed respectively in three different regions of the device which are spaced apart longitudinally of the waveguide axis A. As before, the electrodes in each pair are thin film electrodes deposited on the interface between the layer 14 and the cover 15. The first pair of electrodes 55 and 56 are spaced apart transversely of the waveguide core 11, with the gap between them being laterally offset from the core 11. The second pair of electrodes 57 and 58 are similarly spaced apart transversely of the core 11, but with the gap between them being laterally offset from the core in the opposite direction. The third pair of electrodes 59 and 60 are also spaced apart transversely of the core 11, but the gap between them is generally aligned with the latter.

As can be seen to advantage in FIG. 11A, the electrodes 55 and 56 are so positioned relative to the waveguide core 11 that an electric field E1 produced when a voltage is applied thereto, extends at an angle of essentially +60° to the waveguide surface 13. Similarly, as can be seen to advantage in FIG. 11B, the electrodes 57 and 58 are so positioned relative to the waveguide core 11 that an electric field E2 produced when a voltage is applied thereto, extends at an angle of essentially −60° to the waveguide surface 13. Finally, as can be seen to advantage in FIG. 11C, the electrodes 59 and 60 are so positioned relative to the waveguide core 11 that an electric field E3 produced when a voltage is applied thereto, extends essentially parallel to the waveguide surface 13. Thus, the electric fields E1, E2 and E3 in the three regions of the device are not orthogonal to each other, but rather have their field vectors angularly spaced from one other by around 120°.

This arrangement is intended to avoid problems that can sometimes be encountered in ensuring that the electric fields E1 and E2 in the previous embodiments are exactly orthogonal to one another—any slight deviation from this can give rise to significant PDL. The arrangement is more tolerant of angles, and errors can be corrected to some extent by independent selection of the voltages applied to the three sets of electrodes. Indeed, the electrode arrangements described above with reference to FIGS. 7A to 7C, FIGS. 8A to 8C and FIG. 9 can be adapted so that the electric fields E1 and E2 form angles other than ±45° to the interface 13.

Whereas the invention has been described in relation to what are presently considered to be the most practical and preferred embodiments, it is to be understood that the invention is not limited to the disclosed arrangements but rather is intended to cover various modifications and equivalent constructions included within the spirit and scope of the invention. For example, the electrodes of the electrode arrangement can be deposited on any convenient surface of the device, including the upper surface of the cover 15. In practice, the optimum location for the electrodes will depend upon electro-optical and fabrication considerations. Also, whereas the voltage sources V1 and V2 would normally be AC when used with liquid crystal materials, Dc sources could be used instead where the layer 14 is composed of a different type of electro-optical material.

In addition, in most of the above-described embodiments, the core 11 (which may be circular or rectangular in cross-section) of the waveguide 10 is so disposed that it has a surface thereof exposed at the surface 13 of the cladding 12. However, it is possible to use instead a waveguide of the type wherein the core 11 is completely exposed above the surface 13 so that it forms a ridge thereon. Alternatively, the core 11 can be buried slightly under the surface 13 of the cladding 12 (for example, as depicted in the embodiments of FIGS. 6A to 6C, FIGS. 7A to 7C, and FIGS. 8A to 8C). In all cases, however, the waveguide is of the single-mode type, and some portion of the mode field overlaps the layer 14 of electro-optic material.

What is claimed is:

1. An optical device comprising:
a single-mode optical waveguide having a portion through which optical signals can propagate in a longitudinal direction;
a region of optically active material which at least overlaps a mode field of the waveguide and which forms an interface with the waveguide, the material of said region being such that its refractive index can be varied by applying an electric field thereto; and
an electrode arrangement by means of which there can be applied a first electric field to a first part of said region and a second electric field to a second part of said region, said first and second parts of said region being spaced from one another in the longitudinal direction of said waveguide, said first and second electric fields being generally orthogonal to one another and also being transverse to the longitudinal direction of said waveguide,.

2. An optical device according to claim 1, wherein the material of said region has an extraordinary axis which is aligned parallel to the longitudinal direction of the waveguide.

3. An optical device according to claim 2, wherein the region of optically active material is composed of a polymer-dispersed liquid crystal material in which interference fringes are recorded, with the planes of said fringes being oriented normal to the longitudinal direction of the waveguide.

4. An optical device according to claim 2, wherein the region of optically active material is composed of nematic liquid crystal material.

5. An optical device according to claim 1, wherein the electrode arrangement is such that the first and second electric fields are applied in directions that are respectively generally parallel with and generally normal to said interface.

6. An optical device according to claim 5, wherein the electrode arrangement comprises first electrodes which produce said first electric field when an electrical potential is applied thereto, the first electrodes being spaced apart from one another transversely to the longitudinal direction of the waveguide.

7. An optical device according to claim 6, wherein the electrode arrangement comprises second electrodes which produce said second electric field when an electrical potential is applied thereto, the second electrodes being spaced apart in another direction that is transverse to both said interface and to the longitudinal direction of the waveguide.

8. An optical device according to claim 6, wherein the electrode arrangement comprises second electrodes which produce said second electric field when an electrical potential is applied thereto, one of the second electrodes extends longitudinally of the waveguide, and the other second electrodes is spaced therefrom transversely to the longitudinal direction of the waveguide.

9. An optical device according to claim 1, wherein the electrode arrangement is such that the first and second electric fields are applied in respective directions that are both at an angle to the interface between the waveguide and said region.

10. An optical device according to claim 9, wherein the first and second electric fields are applied generally at angles of +45° and −45° respectively to said interface.

11. An optical device according to claim 10, wherein the electrode arrangement comprises a first electrode set including a first electrode generally aligned with a core of the waveguide and a second electrode positioned obliquely to one side of said core, and a second electrode set including a first electrode generally aligned with said core and a second electrode positioned obliquely to the opposite side of said core.

12. An optical device according to claim 11, wherein the first electrode of the first electrode set and the first electrode of the second electrode set comprise a common electrode extending in the longitudinal direction of the waveguide.

13. An optical device according to claim 1, wherein the electrode arrangement is operative such that at least one of the first and second electric fields varies in magnitude in the longitudinal direction of the waveguide.

14. An optical device according to claim 13, wherein electrodes of the electrode arrangement are positioned at an angle to the longitudinal direction of the waveguide.

15. An optical device according to claim 1, wherein said region of optically active material is formed as a layer on a surface of said waveguide.

16. An optical device comprising:
a single-mode optical waveguide having a portion through which optical signals can propagate in a longitudinal direction;
a region of optically active material which at least overlaps a mode field of the waveguide and which forms an interface with the waveguide, the material of said region being such that its refractive index can be varied by applying an electric field thereto; and
an electrode arrangement by means of which there can be applied a plurality of electric fields to respective parts of said region that are spaced from one another in the longitudinal direction of said waveguide, said plurality of electric fields being transverse to the longitudinal direction of the waveguide and having their field vectors directed at respective different angles with respect to said interface.

17. An optical device according to claim 14, wherein the field vectors of said electric fields are directed at respective angles that are generally equi-angularly spaced from one another.

18. An optical device according to claim 15, wherein the electrode arrangement is such that three electric fields are applied, and such that their field vectors are angularly spaced at intervals of generally 120°.

19. An optical device according to claim 16, wherein the three electric fields are applied in directions that are essentially parallel to said interface and at angles of +60° and −60° to said interface, respectively.

20. An optical device comprising:
a single-mode optical waveguide having a portion through which optical signals can propagate in a longitudinal direction;
a region of optically active material which at least overlaps a mode field of the waveguide and which forms an interface with the waveguide, the material of said region being such that its refractive index can be varied by applying an electric field thereto; and
an electrode arrangement by means of which there can be applied a first electric field to a first part of said region, a second electric field to a second part of said region and a third electric field to a third part of said region, said first, second and third parts of said region being spaced from one another in the longitudinal direction of the waveguide, the first, second and third electric fields being directed transversely of said waveguide and at respective different angles to said interface that are angularly spaced from one another at intervals of generally 120°.
